(19) United States
(12) Patent Application Publication
(10) Pub. No.: US 2005/0245629 A1
(43) Pub. Date: Nov. 3, 2005

(54) Catalyst combinations for increasing trimer content in foam

(76) Inventors: Robert A. Grigsby JR., Austin, TX (US); Robert L. Zimmerman, Austin, TX (US); Ernest L. Lister JR., Round Rock, TX (US); Pierre Gilbert Henri Jean Chaffanjon, Austin, TX (US)

Correspondence Address: Huntsman Corporation, P O Box 15730, Austin, TX, 78761, US

(21) Appl. No.: 10/521,102

(22) PCT Filed: Jul. 18, 2002
(86) PCT No.: PCT/US02/22807

§ 371 Date: Jan. 11, 2005

(51) Int. Cl. B01J 31/00; C08G 18/00

(52) U.S. Cl. 521/159; 502/150; 502/167; 502/170

(57) ABSTRACT

Provided herein are compositions which are useful as catalysts in the production of polyisocyanurate foams. The compositions of the invention comprise N, N, N′-trimethylaminoethyl-ethanolanine in combination with one other catalysts useful in promoting trimerization of isocyanates. By promoting trimerization, isocyanate content of the foam is decreased which leads to a foam having better bum properties over prior art isocyanurate foams. Decreasing the isocyanate content of a foam should also lead to quicker de-mold of a molded foam because of reduced stickiness.

### TECHNICAL FIELD

This invention relates to catalyst combinations useful in the manufacture of polyurethane-based foam products. More particularly it relates to catalyst combinations which promote trimerization of isocyanates during the production of a polyisocyanurate foam final product.

### BACKGROUND INFORMATION

The chemical compound: N,N,N′-trimethylaminoethyl-ethanolamine (CAS#2212-32-0) is frequently used as a catalyst in the manufacture of polyurethane based foam products, to promote the reaction between an isocyanate group in one or more isocyanates present and a hydroxy group in one or more polyols present in the precursors from which the polyurethane is formed. N,N,N′-trimethyl- aminoethyl-ethanolamine is available from Huntsman Petrochemical Corporation of Austin, Texas under the tradename of JEFFCAT® Z-110, and has the structure:
(CH₃)₂NCH₂CH₂N(CH₃)CH₂CH₂OH.

We know that this catalyst will cause a small proportion of the isocyanate groups present in the polyurethane precursor materials to react with other isocyanate groups present and form a trimer, for example the trimer of MDI. However, the amount of trimerization which occurs is not of a sufficient degree of magnitude to effect significant changes in the reaction profile or the physical properties of polyurethane foam products produced using this catalyst. Often, this material is used as a “blowing catalyst” in a foam, and as such is employed primarily to enhance the reaction between the isocyanate and water to produce gaseous CO₂ in situ, which functions as a blowing agent. It has been shown to have little activity towards promotion of isocyanurate formation (see J. Cell Plastic Vol. 37, page 75).

It is believed that the generation of a large number of isocyanurate (isocyanate trimer) groups in a foam should improve the burn properties of an isocyanurate foam. It is also believed that decreasing the isocyanate content of a foam should also lead to quicker de-mold of a molded foam and improved physical properties, because of reduced stickiness. However, no mention in the prior art has been made for promoting the formation of increased trimer formation using a mixed catalyst system as we disclose herein, particularly a mixed catalyst system in which, oddly enough, one of the components does not itself promote trimer formation to a large extent.

### SUMMARY OF THE INVENTION

The present invention provides a catalyst combination useful in the formation of polyisocyanurate foam from an isocyanate and a polyol. The catalyst combination comprises: an amine component that comprises N,N,N′-trimethylaminoethyl-ethanolamine; and a trimer catalyst component. The invention also provides a process for producing an isocyanurate foam product comprising the steps of: a) providing an isocyanate and a polyol; b) providing a blowing agent; c) providing a catalyst that comprises: i) an amine component comprising N,N,N′-trimethylaminoethyl-ethanolamine, and ii) a trimer catalyst component; and d) contacting the isocyanate and the polyol in the presence of the catalyst and the blowing agent.

### BRIEF DESCRIPTION OF THE DRAWINGS

In the annexed drawings:

FIG. 1 is a graphical representation of the trimer content in a plurality of foam-yielding formulations that contain varied catalyst combinations;

FIG. 2 is a graphical representation of the increase in trimer content during the course of the foam-forming reaction in a plurality of foam-yielding formulations that contain varied catalyst combinations, at three different index levels;

FIG. 3 is a graphical representation of the decrease in isocyanate content during the course of the foam-forming reaction in a plurality of foam-yielding formulations that contain varied catalyst combinations, at three different index levels;

FIG. 4A is a graphical representation of the increase in trimer content during the course of the foam-forming reaction in a plurality of foam-yielding formulations that contain varied catalyst combinations, at an index level of 200;

FIG. 4B is a graphical representation of the increase in trimer content during the course of the foam-forming reaction in a plurality of foam-yielding formulations that contain varied catalyst combinations, at an index level of 300;

FIG. 4C is a graphical representation of the increase in trimer content during the course of the foam-forming reaction in a plurality of foam-yielding formulations that contain varied catalyst combinations, at an index level of 500;

FIG. 5A is a graphical representation of the decrease in isocyanate content during the course of the foam-forming reaction in a plurality of foam-yielding formulations that contain varied catalyst combinations, at an index level of 200;

FIG. 5B is a graphical representation of the decrease in isocyanate content during the course of the foam-forming reaction in a plurality of foam-yielding formulations that contain varied catalyst combinations, at an index level of 300; and

FIG. 5C is a graphical representation of the decrease in isocyanate content during the course of the foam-forming reaction in a plurality of foam-yielding formulations that contain varied catalyst combinations, at an index level of 500.

### DETAILED DESCRIPTION OF THE INVENTION

The present invention describes the benefits discovered by our combination of JEFFCAT® Z-110 (N,N,N′-trimethylaminoethyl-ethanolamine) with a trimer catalyst, such as potassium octate. Such a combination is seen to significantly increase the conversion of isocyanate groups into isocyanurate groups (in a reacting isocyanate-derived foam) over other known catalysts similarly employed. When this is caused to occur according to the invention, overall efficiency in utilization of the isocyanate is increased.

We know that higher amounts of isocyanurate (or trimer) groups in the finished foam generally lead to decreased “burning” of the foam when it is subjected to an open flame, which is often viewed as improved burn resistance of the foam. Higher conversion rates of the isocyanate also lead to improved K-factor drift in rigid polyisocyanurate insulation foam. This is believed to be due to the formation of reduced amounts of carbon dioxide in the foam resulting from a lessened amount of unreacted isocyanate in the foam.

We have found that JEFFCAT® Z-110 is unique in exhibiting the unexpected behavior of rapidly catalyzing the trimerization of an isocyanate to its corresponding isocyanurate (generation of more trimer groups in a foam), if the temperature of the foam is raised or permitted to rise above a certain temperature. We have also found that the combination of potassium salts with JEFFCAT® Z-110 produces an increased number of isocyanurate (trimer) groups along with an attendant decrease in isocyanate content of a fresh polyurethane foam produced using such a catalyst combination, as compared with prior art catalysts. Thus, a synergistic effect has been observed in the performance of a catalyst combination including JEFFCAT® Z-110 and other trimer catalysts, the use of which combination as catalyst in the system further promotes isocyanurate formation and decreased isocyanate content.

The present invention employs JEFFCAT® Z-110 with at least one trimerization-promoting catalyst. JEFFCAT® Z-110 can be used in combination with other amine and or tin catalysts, or any combinations of the foregoing. Further, known blowing agents can also be present in the formulation, as the use of such blowing agents is known to those skilled in the art, such as: non-CFC-containing blowing agents, water, HCFC's and CFC-containing blowing agents, with the pentanes (including: n-pentane, cyclopentane, neopentane, isopentane, and mixtures thereof) being especially-preferred as blowing agent.

In the first set of experiments, a reacting foam (an admixture comprising both the “A” and “B” components of the formulation) was poured onto a heated probe that was set up on a ReactIR® 1000 instrument, available from Mettler-Toledo Corporation of Columbus, Ohio. In this way, it was possible to collect real-time FTIR data on the reacting foam. The heated probe was started at room temperature, and ramped up at a constant rate to 180° C. during a time interval of 900 seconds. All the foam formulations were made and poured in identical fashion, except for the catalyst components used in the foam formulations, whose compositions were varied. The base polyol, B-component, was made by combining: 100 parts by weight (“pbw”)

STEPHANOL® PS-2352 with 20 pbw EXXSOL® 1600, 2.5 pbw B-8477, and 0.5 pbw water. B-8477 is a modified siloxane material sold by Goldschmidt AG of Germany. The catalyst was added to the base polyol and mixed until homogeneous. Then, the B-component containing the catalyst was admixed with the isocyanate, RUBINATE(® M.

TABLE I

| | Example # | | | | | | | | | | |
|---|---|---|---|---|---|---|---|---|---|---|---|
| | 1 | 2 | 3 | 4 | 5 | 6 | 7 | 8 | 9 | 10 | 11 |
| Base Polyol | 54.4 | 54.4 | 54.4 | 54.4 | 54.4 | 54.4 | 54.4 | 54.4 | 54.4 | 54.4 | 54.4 |
| JEFFCAT ® ZF-20 | 0.5 | — | — | — | — | — | — | — | — | — | — |
| JEFFCAT ® ZF-10 | — | 0.59 | — | — | — | — | — | — | — | — | — |
| JEFFCAT ® PMDETA | — | — | 0.36 | — | — | — | — | — | — | — | — |
| JEFFCAT ® TR-90 | — | — | — | 0.26 | — | — | — | — | — | — | — |
| JEFFCAT ® Z-110 | — | — | — | — | 0.46 | — | — | — | — | — | — |
| JEFFCAT ® ZR-50 | — | — | — | — | — | 0.51 | — | — | — | — | — |
| no catalyst | — | — | — | — | — | — | 0.00 | — | — | — | — |
| K+ octoate | — | — | — | — | — | — | | 0.38 | — | — | — |
| K+ acetate | — | — | — | — | — | — | — | — | 0.50 | — | — |
| JEFFCAT ® Z-80 | — | — | — | — | — | — | — | — | — | 0.50 | — |
| JEFFCAT ® ZR-40 | — | — | — | — | — | — | — | — | — | — | 0.42 |
| RUBINATE ® M | 85.7 | 85.7 | 85.7 | 85.7 | 85.7 | 85.7 | 85.7 | 85.7 | 85.7 | 85.7 | 85.7 |

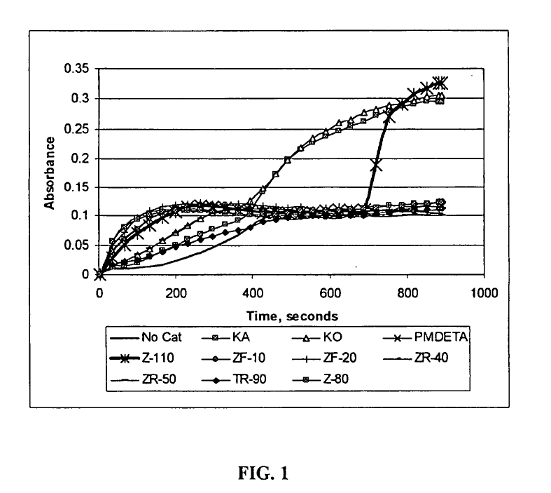

Online FTIR data was collected on the mixtures prepared as set forth in examples 1-11 of Table I above, in which all parts are parts by weight. A graph showing the trimer peak, appearing around 1409 cm⁻¹, as a function of time is shown in FIG. 1. As can be seen, the only tertiary amine product exhibiting a significant effect on trimer formation was JEFFCAT® Z-110. Trimer formation occurred with JEFFCAT® Z-110 once the foam reached a certain temperature, about 54 degrees C. Only potassium acetate or potassium octoate showed similar trimer formation, but at a much earlier time in the reaction, and when the temperature is lower, which probably indicates a different catalytic mechanism than that caused by the Z-110.

A second experiment was set up such that the index of the foam was varied and a combination of potassium octoate, a trimerization-promoting catalyst, and in a first instance JEFFCAT® PMDETA (pentamethyldiethylenetriamine) and in a second instance JEFFCAT® Z-110 were used as the amine catalyst. The index of an isocyanate-derived foam is expressed as the ratio of the number of isocyanate groups to hydroxy groups in the polyol used. An index of 2.0 (sometimes expressed as “200”), commonly referred to those skilled in the art, means that there are two —NCO groups for each —OH group. We used JEFFCAT® Z-110 here to see if additional improvements in isocyanate conversion and trimer formation would occur. The amount of catalyst used was such that the cream time was 15 seconds.

A master polyol blend was made using the following amounts of the specified materials:

| | | | |
|---|---|---|---|
| STEPHANOL ® PS | 100.0 pbw | GENETRON ® 141B | 27.2 pbw |
| 2352 | | | |
| TEGOSTAD ® B-84PI | 2.0 pbw | Water | 0.5 pbw |

The two catalyst combinations which were tested were prepared using the following amounts of the specified materials:

| Catalyst A | | Catalyst B | |
|---|---|---|---|
| Potassium octoate | 89.7 pbw | Potassium octoate | 89.7 pbw |
| JEFFCAT ® PMDETA | 10.3 pbw | JEFFCAT ® ZF-110 | 10.3 pbw |

The amount of each catalyst combination above needed to get a 15 second cream time is shown in Table II below:

TABLE II

| | Example | | | | | |
|---|---|---|---|---|---|---|
| | 12 | 13 | 14 | 15 | 16 | 17 |
| Polyol blend (g) | 38.9 | 38.9 | 38.9 | 38.9 | 38.9 | 38.9 |
| RUBINATE ® | 38.7 | 38.7 | 57.8 | 57.8 | 96.9 | 96.9 |
| M | | | | | | |
| Catalyst A (g) | 0.45 | — | 0.65 | — | 0.78 | — |
| Catalyst B (g) | — | 0.55 | — | 0.70 | — | 1.0 |
| Index | 200 | 200 | 300 | 300 | 500 | 500 |
| Cream time (sec.) | 15 | 15 | 15 | 15 | 15 | 15 |
| String gel time | 45 | 35 | 36 | 34 | 45 | 34 |
| (sec.) | | | | | | |
| Tack-free time | 66 | 52 | 51 | 51 | 58 | 43 |
| (sec.) | | | | | | |
| Rise Time (sec.) | 89 | 87 | 79 | 79 | 88 | 78 |

“Cream Time” is the amount of time elapsed between initial mixing of the isocyanate and polyol portions and when the foam can be visually observed to begin to react, as evident from the presence of gas bubbles. “String Gel Time” is the amount of time elapsed between initial mixing of the isocyanate and polyol portions and when a string of material can be pulled out of the reacting foam. “Tack-free Time” is the amount of time elapsed between initial mixing of the isocyanate and polyol portions and when nothing will stick to the surface of the reacting foam. “Rise Time” is the amount of time elapsed between initial mixing of the isocyanate and polyol portions and when the foam ceases to expand further.

Once the conditions necessary to produce a cream time of fifteen seconds were determined for each combination, a live reacting foam representing each formulation was poured into a cup and the exotherm from the center of the cup was measured and recorded into the FTIR equipment. An individual exotherm profile was collected for each formulation and was subsequently used to program the heated probe on the FTIR instrument. Before a run was made on the FTIR heated probe, an 8-oz paper cup with a one-inch hole in the bottom of the cup, was placed on top of the heated probe. The paper cup was slid 1 inch below the top of the probe. The heated probe was then programmed with the temperature profile that had been collected earlier with the particular formulation. The B-component, with added catalyst, was premixed for 5 seconds using a 3500-rpm mixer. The RUBINATE® M isocyanate was then added to the cup. Simultaneously, upon commencement of mixing, the FTIR instrument began collecting data. The foam was mixed for seven seconds, and then poured on top of the heated probe such that the liquid covered the probe's top surface. FTIR data was then collected for 1000 seconds, during which time, incidentally, 552 spectra were collected while the heated probe followed the heat profile programmed into it.

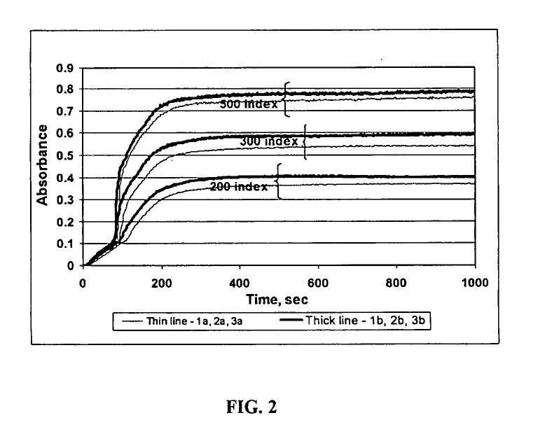

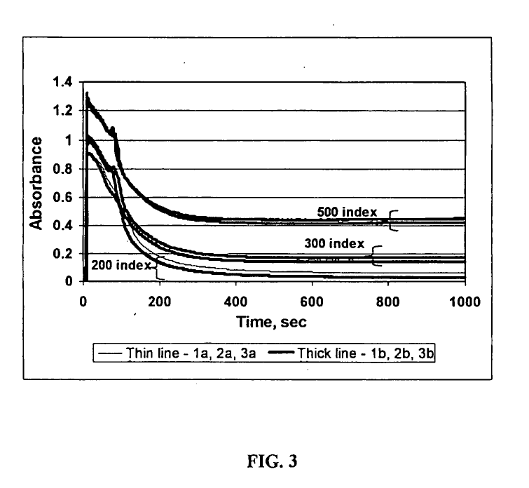

The FTIR spectra so obtained were collected and analyzed. The top of the peaks were converted into data that was exported to an EXCEL® spreadsheet and graphed. The resulting peak profiles are shown in FIGS. 2 and 3. FIG. 2 shows the effect of catalyst and index of the foam on the amount of trimer found in the foam. Using JEFFCAT® Z-110 in combination with potassium octoate, higher trimer levels are seen in the foam at all indexes tested. FIG. 3 shows the disappearance of the isocyanate as a function of catalysts and index. Here again, the catalyst system containing JEFFCAT® Z-110 makes more effective utilization of the isocyanate in the foam than the system not containing JEFFCAT® Z-110. These graphical results show that JEFFCAT® Z-110 significantly increases the trimer content of a foam, and increases the overall conversion of isocyanate groups in a foam.

In a third set of experiments, the hydrocarbon blowing agent known as EXXOL®1600, available from Exxon Chemical Corp., and which contains a mixture of cyclopentane and isopentane, was used to make the polyisocyanurate (“PIR”) foam. The formulations and rise profiles for the foams are shown in the table below, in which as in all tables herein, all parts are expressed in parts by weight:

TABLE III

| | Example | | | | | |
|---|---|---|---|---|---|---|
| | 18 | 19 | 20 | 21 | 22 | 23 |
| STEPHANOL ® PS 2352 | 25.48 | 25.48 | 24.1 | 24.1 | 21.54 | 21.54 |
| B-8477 | 0.51 | 0.51 | 0.48 | 0.48 | 0.43 | 0.43 |
| Water | 0.13 | 0.13 | 0.16 | 0.16 | 0.22 | 0.22 |
| EXXOL ® 1600 | 5.66 | 5.66 | 7.02 | 7.02 | 9.57 | 9.57 |
| Catalyst A | 0.50 | — | 0.62 | — | 0.75 | — |
| Catalyst B | — | 0.70 | — | 0.75 | — | 1.12 |
| RUBINATE ® M | 32.7 | 32.7 | 48.1 | 48.1 | 77.2 | 77.2 |
| Index | 200 | 200 | 300 | 300 | 500 | 500 |
| cream time, sec | 15 | 15 | 15 | 15 | 15 | 15 |
| string gel time, sec | 50 | 32 | 55 | 44 | 105 | 62 |
| tack free time, sec | 67 | 42 | 110 | 65 | 165 | 117 |
| rise time, sec | 98 | 66 | 97 | 87 | 140 | 102 |

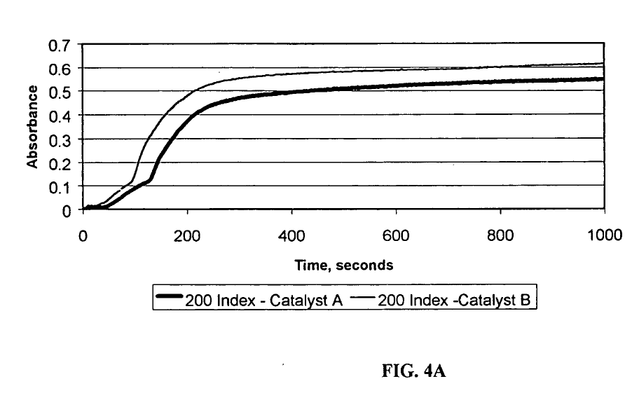

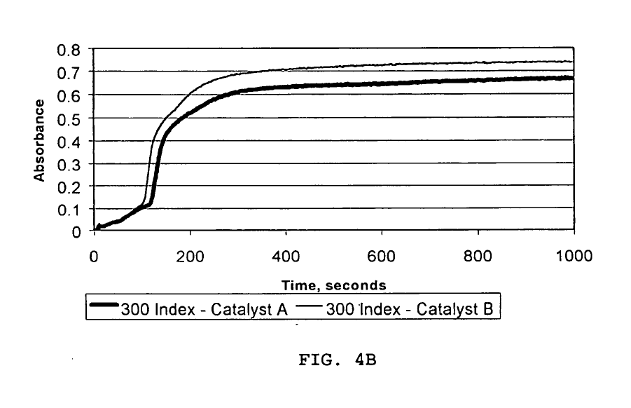

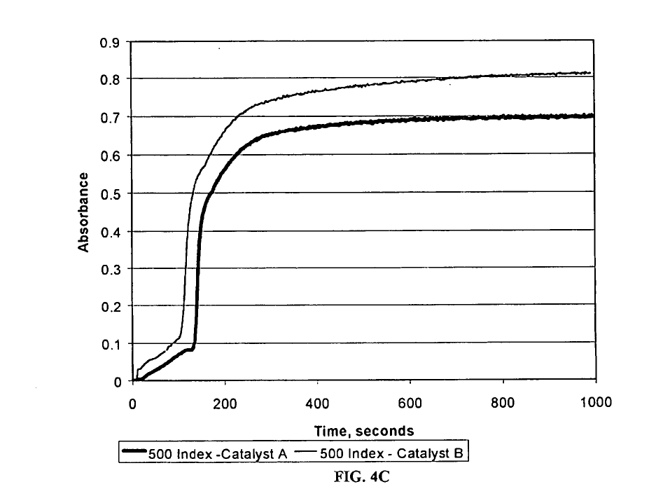

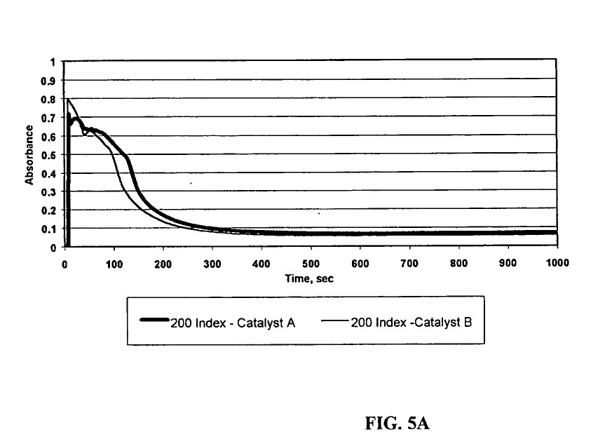

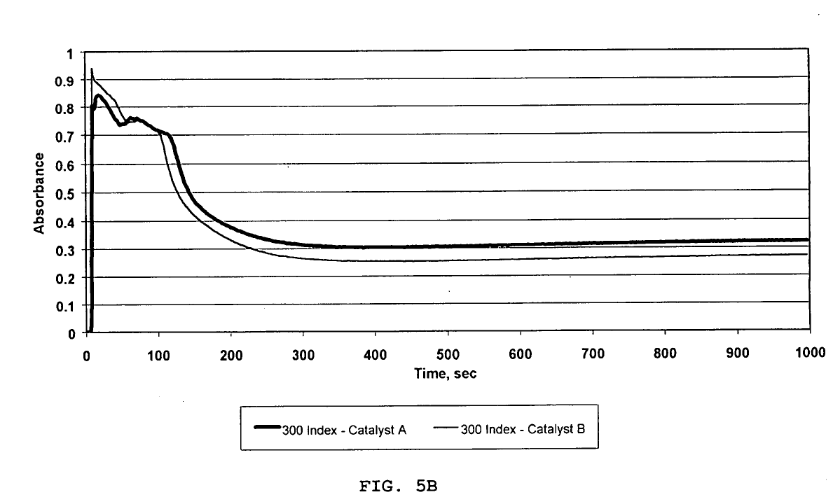

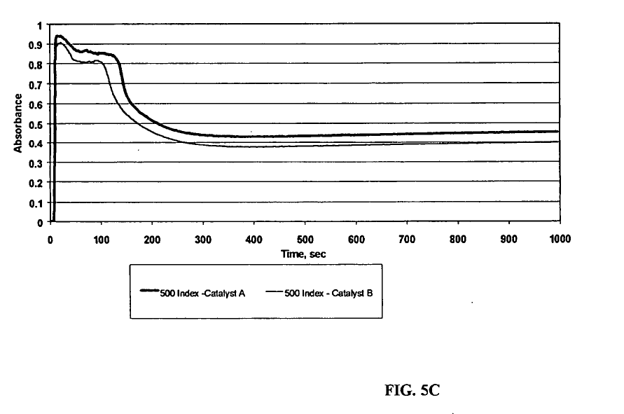

The foams of Table III were poured onto the FTIR probe in the manner described earlier. The results for the trimer absorption peak grows in the way pictorially described in FIGS. 4A, 4B, and 4C. The results for the isocyanate absorbances are shown in FIGS. 5A, 5B, and 5C.

The (A) component, or isocyanate component, useful in a formulation in which a catalyst combination according to the invention may be employed can consist of any number of suitable aromatic or aliphatic-based isocyanates, prepolymers, or quasi-prepolymers. These are standard isocyanate compositions known to those skilled in the art. Preferred examples include MDI-based quasi-prepolymers such as those available commercially as RUBINATE® M, RUBINATE® 1850 RUBINATE® 9480, RUBINATE® 9484, and RUBINATE® 9495 from Huntsman International, LLC. Aromatic polyisocyanates such as toluene diisocyanate, diphenylmethane-4,4′-diisocyanate, and positional isomers of the foregoing, polymerized isocyanates, such as polymeric MDI and the like; aliphatic polyisocyanates such as hexamethylenediisocyanate and the like; alicyclic polyisocyanates such a isophoronediisocyanate and the like; pre-polymers with end isocyanate groups such as toluenediisocyanate pre-polymer and diphenylmethane-4,4′-diisocyanate pre-polymer which are obtained by the reaction of the above-mentioned substances with a polyol; denatured isocyanate such as carbodiimide denatured substances; and further mixed polyisocyanates thereof. The isocyanates employed in component (A) may include aliphatic isocyanates of the type described in U.S. Pat. No. 4,748,192. These include aliphatic diisocyanates and, more particularly, are the trimerized or the biuretic form of an aliphatic diisocyanate, such as hexamethylene diisocyanate, or the biftmctional monomer of the tetraalkyl xylene diisocyanate, such as the tetramethyl xylene diisocyanate. Cyclohexane diisocyanate is also to be considered a useful aliphatic isocyanate. Other useful aliphatic polyisocyanates are described in U.S. Pat. No. 4,705,814. They include aliphatic diisocyanates, for example, alkylene diisocyanates with 4 to 12 carbon atoms in the alkylene radical, such as 1,12-dodecane diisocyanate and 1,4-tetramethylene diisocyanate. Also useful are cycloaliphatic diisocyanates, such as 1,3 and 1,4-cyclohexane diisocyanate as well as any mixture of these isomers, 1-isocyanato-3,3,5-trimethyl-5-isocyanatomethylcyclohexane (isophorone diisocyanate); 4,4′- dicyclohexylmethane diisocyanate, 2,2′- dicyclohexylmethane diisocyanate and 2,4′- dicyclohexylmethane diisocyanate as well as the corresponding isomer mixtures, and the like.

Other amine catalyst components useful as components in producing a foam according to the invention include, without limitation: JEFFCAT® TAP, JEFFCAT® ZF-22, JEFFCAT® DD, tetramethylbutanediammine, dimorpholinodiethylether, JEFFCAT®MEM, JEFFCAT®MEM DM-70, JEFFCAT®MEM bis(dimethylaminoethoxy)ethane, JEFFCAT® NMM, JEFFCAT® NEM, JEFFCAT® PM, JEFFCAT® M-75, JEFFCAT® MM-20, JEFFCAT® MM-27, JEFFCAT® DM-22, Pentamethydiethylenetriamine, Tetramethylethylenediammine, Tertamethylaminopropylamide, 3-dimethylamino-N,N-dimethylpropylarnide, TMR®, TMR®2, TMR®3, TMR®4 or any material that is known to those skilled in the art as 2 0 being capable of functioning as a blowing or gelling catalyst in a polyurethane system. All of the foregoing JEFFCAT® trademark materials are available from Huntsman Petrochemical Corporation, 7114 North Lamar Boulevard, Austin, Tex. TMR® is a registered trademark of Air Products and Chemicals, Inc., of Allentown, Pennsylvania.

Polyols useful in providing a foam according to the present invention include aromatic polyesterpolypls, amino polyols, mannich polyols, sucrose-derived polyols, sorbitol-derived polyols, polyetherpolyol, polymer polyols, and polyesterpolyols having 2 or more reactive hydroxyl groups. Polyetherpolyols include, for example, polyhydric alcohols such as glycols, glycerin, pentaerythritol, and sucrose; aliphatic amine compounds such as ammonia, and ethyleneamine; aromatic amine compounds such as toluene diamine, and diphenylmethane-4,4′-diamine; and/or a polyetherpolyol obtained by adding ethylene oxide or propylene oxide to a mixture of above-mentioned compounds. Polymer polyol is exemplified by a reaction product of said polyetherpolyol with ethylenic unsaturated monomer, such as butadiene, acrylonitrile, and styrene, the reaction being conducted in the presence of a radical polymerization catalyst. Polyesterpolyols include those which are produced from a dibasic acid and a polyhydric alcohol such as, for example, polyethyleneadipate and polyethyleneterephthalates which may include those products reclaimed from waste materials. Combinations of any of the foregoing are also useful as polyols.

Blowing agents useful in accordance with the present invention are exemplified by low boiling point hydrocarbons such as pentane, halogenated hydrocarbons, carbon dioxide, acetone, and/or water. Known halogenated methanes and halogenated ethanes may be used as halogenated hydrocarbons. Among them, preferably are chlorofluorocarbon compounds such as trichloromonofluoromethane (R-11), dichlorotrifluoroethane (R-123), dichloromonofluoroethane (R-141b), R-134A, R-141B, R-245fa, and the like. The amount of the foaming agent to be used is not particularly limited, but the amount of chlorofluorocarbon to be used is usually not larger than 35 parts by weight, preferably 0 to 30 parts by weight, based on 100 parts of polyol, and the amount of water to be used is not less than 2.0 parts, preferably 3.0 to 20.0 parts. The stabilizer is selected, for example, from non-ionic surfactants such as organopolysiloxanepolyoxyalkylene copolymers, silicone-glycol copolymers, and the like, or a mixture thereof. The amount of the stabilizer is not particularly specified, but is usually present at about 0 to 2.5 parts by weight based on 100 parts by weight of polyol.

According to the present invention, other auxiliary agents may be added if desired or necessary. They include flame retardants, coloring agents, fillers, oxidation-inhibitors, ultraviolet ray screening agents, and the like known to those skilled in the art.

The polyurethane foam prepared by use of the amine catalyst of the present invention may be flexible foam, HR foam, semi-rigid foam, rigid foam, microcellular foam, elastomer, and the like which are prepared by the conventional known one-shot method, the pre-polymer method, and the like. Among these known processes, particularly preferable is the process for producing polyurethane foam by using a foaming agent which is processed in a combined form such as foil, coating, or border material, or by molding integratedly, with other materials. Said other materials referred to above include resins such as polyvinylchloride resin, ABS resin, polycarbonate resin, and the like, metals, glasses, and the like. Examples of applications of a foam product made according to the invention include interior articles of automobiles such as instrument panels, seats, head rests, arm rests, and door panels, as well as packaging materials, products of continuous lamination processes, metal panel coatings, and the like.

The amount of the amine catalyst used in a composition from which a foam may be produced in accordance with the present invention is in the range of from 0.02 to 10 parts, more preferably 0.1 to 5 parts, by weight based on 100 parts of the polyol. These weight values include both the JEFFCAT® Z-110 catalyst and any other amine catalyst used the reactive catalyst. In addition, other known tertiary amine catalysts, organic carboxylic acid salts thereof, and organo tin compounds which are usually used as co-catalysts may be employed as auxiliary catalysts.

The amount of trimer catalyst present in a composition from which a foam may be produced in accordance with the instant invention is in the range of from 0.02 to 10 parts, more preferably 0.1 to 5 parts, by weight based on 100 parts of the polyol. As used in this specification and the appended claims “trimer catalyst” means any catalyst which promotes the conversion of isocyanate functionality into a trimer structure, as such trimer structure is known to those skilled in the art as isocyanurates. Trimer catalysts include alkali salts of an carboxylic acids, such as sodium, potassium, lithium or cesium. During formation of the isocyanate trimer, three —NCO groups react with one another to form an isocyanurate structure. Typical trimer catalysts include potassium octoate and potassium acetate. In addition, certain amines may also function as trimer catalysts, some of which include: JEFFCAT® TR-52 available from Huntsman Petrochemical Corporation of Austin Texas, and TMR®, TMR2®, TMR3, which are available from Air Products and Chemicals, Inc.

The temperature range over which a foam product according to the invention may be produced is any temperature in the range from about 25° C. to about 200° C. The pressure range over which a foam product according to the invention may be produced is any pressure in the range from about 1 pound per square inch (“psi”) to about 3000 psi.

In the process for producing foam products using JEFFCAT® Z-110 in combination with a trimer catalyst according to the present invention, polyols, polyisocyanates, and foaming agents, stabilizers, and if necessary, other auxiliary agents which are hitherto known, including without limitation, flame retardants, may be employed.

Although this invention has been shown and described with respect to certain preferred embodiments, it is obvious that equivalent alterations and modifications will occur to others skilled in the art upon reading and understanding of this specification and the appended claims. The present invention includes all such modifications and alterations, and is limited only by the scope of the following claims.

1) A catalyst useful in the formation of polyisocyanurate foam from an isocyanate and a polyol comprising:
a) an amine component comprising N,N,N′-trimethylaminoethyl-ethanolamine; and
b) a trimer catalyst component.

2) A catalyst according to claim 1 wherein said trimer catalyst comprises an alkali metal salt of a carboxylic acid.

3) A catalyst according to claim 2 wherein said salt is selected from the group consisting of: octoate salts and acetate salts of an element selected from the group consisting of: lithium, sodium, potassium, and cesium.

4) A catalyst according to claim 1 further comprising an additional amine component.

5) A catalyst according to claim 4 wherein said additional amine component is selected from the group consisting of: pentamethyldiethylenetriamine; dimethylcyclohexylamine; 2,2′-oxybis (N,N-dimethylethanamine); aminophenol; dimethylethanolamine; dimethylpiperazine; N-ethylmorpholine; N-methylmorpholine; 1,3,5-triazine-1,3,5 (2H, 4H, 6H)-tripropanamine, N, N, N′,N′, N″, N″-hexamethyl; 1,3-propanediamine,N′-(3-(dimethylamino)propyl)-N,N-dimethyl; 2-propanol, 1-(bis(3-dimethylamino)propyl) amino); 2-((2-(2-(dimethylamino)ethoxy)ethyl)mathyl-amino)-ethanol; dimethylaminoethoxyethanol; 1,3-propanediamine, N-[3-(dimethylamino)propyl]-N,N′,N′-trimethyl; 1,3-propanediamine, N, N-bis[3-(dimethylamino)propyl]-N′,N′-dimethyl; morpholine, 4,4′-(oxydi-2,1-ethanediyl)bis-dimorpholino ethane; and triethylenediamine.

6) A catalyst according to claim 1, further comprising an organotin compound.

7) A process for producing an isocyanurate foam product comprising the steps of:
a) providing an isocyanate and a polyol;
b) providing a catalyst comprising:
i) an amine component comprising N,N,N′-trimethylaminoethyl-ethanolamine; and
ii) a trimer catalyst component;
c) contacting said isocyanate and said polyol in the presence of said catalyst.

8) A process according to claim 7 wherein said isocyanate is selected from the group consisting of: aromatic di-isocyanates, polymeric isocyanates, aliphatic di-isocyanates, and aliphatic tri-isocyanates.

9) A process according to claim 7 wherein said polyol is selected from the group consisting of: aromatic polyesterpolyols, amnino polyols, mannich polyols, sucrose-derived polyols, sorbitol-derived polyols, and combinations thereof.

10) A process according to claim 7 wherein said trimer catalyst is selected from the group consisting of: potassium octoate; potassium acetate; JEFFCAT® TR-52; 2-hydroxypropyl trimethylammonium 2-ethylhexanoate; and 2-hydroxypropyl trimethylammonium formate.

11) A process according to claim 7 wherein said catalyst further comprises: iii) a second amine component selected from the group consisting of: pentamethyldiethylenetriamine; dimethylethanolamine; 2, 2′-oxybis (N,N-dimethylethanamine); triethylenediamine; 1,3,5-triazine-1,3,5 (2H, 4H, 6H)-tripropanamine, N, N, N′,N′, N″, N″-hexamethyl; 1,3-propanediamine, N, N-bis[3-(dimethylamino)propyl]-N′,N′-dimethyl; aminophenol; and 1,3-propanediamine, N-[3-(dimethylamino)propyl]-N,N′,N′-trimethyl.

12) A process for producing an isocyanurate foam product comprising the steps of:
a) providing an isocyanate and a polyol;
b) providing a blowing agent;
c) providing a catalyst comprising:
i) an amine component comprising N,N,N′-trimethylaminoethyl-ethanolamine; and
ii) a trimer catalyst component;
d) contacting said isocyanate and said polyol in the presence of said catalyst and said blowing agent.

13) A process according to claim 12 wherein said isocyanate is selected from the group consisting of: aromatic di-isocyanates, polymeric isocyanates, aliphatic di-isocyanates, and aliphatic tri-isocyanates.

14) A process according to claim 12 wherein said polyol is selected from the group consisting of: aromatic polyesterpolyols, amino polyols, mannich pdlyols, sucrose-derived polyols, sorbitol-derived polyols, and combinations thereof.

15) A process according to claim 12 wherein said trimer catalyst is selected from the group consisting of: 2-hydroxypropyl trimethylammonium 2-ethylhexanoate; and 2-hydroxypropyl trimethylammonium formate.

16) A process according to claim 12 wherein said blowing agent is selected from the group consisting of: water, carbon dioxide, pentane, isopentane, cyclopentane, butane, R-141b®, and R-245FA®.

17) A process according to claim 12 wherein said catalyst further comprises: iii) a second amine component selected from the group consisting of:
pentamethyldiethylenetriamine; dimethylethanolamine; 2, 2′-oxybis (N,N-dimethylethanamine); triethylenediamine; 1,3,5-triazine-1,3,5 (2H, 4H, 6H)-tripropanamine, N, N, N′,N′, N″, N″-hexamethyl; 1,3-propanediamine, N, N-bis[3-(dimethylamino)propyl]-N′,N′-dimethyl; aminophenol; and 1,3-propanediamine, N-[3-(dimethylamino)propyl]-N,N′,N′-trimethyl.

18) A polyisocyanurate foam comprising N,N,N′-trimethylaminoethyl-ethanolamine.

19) A polyisocyanurate foam comprising N,N,N′-trimethylaminoethyl-ethanolamine and a trimer catalyst.

20) A foam according to claim 18 wherein said trimer catalyst is selected from the group consisting of: potassium octoate, and potassium acetate.
